(19) United States
(12) Patent Application Publication
(10) Pub. No.: US 2008/0160283 A1
(43) Pub. Date: Jul. 3, 2008

(54) Photochromic Articles and Their Method of Making

(76) Inventor: Ronald C. Wiand, Troy, MI (US)

Correspondence Address: RONALD L. HOFER, 122 LINDBERGH LANE, MOORESVILLE, NC, 28117, US

(21) Appl. No.: 11/883,863

(22) PCT Filed: Feb. 7, 2006
(86) PCT No.: PCT/US06/04294

§ 371 Date: Aug. 7, 2007

Related U.S. Application Data
(60) Provisional application No. 60/651,139, filed on Feb. 8, 2005.

(51) Int. Cl. B32B 3/26; B05D 3/02

(52) U.S. Cl. 428/304.4; 427/487

(57) ABSTRACT

A photochromic article such as an ophthalmic lens has a substrate of a cross-linked organic polymeric matrix with a surface layer. The polymer in the surface layer is more porous than the polymer in the remainder of the substrate and the polymeric matrix in the surface layer contains a photochromic moiety. A method of making a photochromic article includes the steps of curing a cross-linkable pre-polymer to beyond a gel state to form a substrate of a partially cured polymeric matrix, inhibiting further curing of a surface layer of the substrate of partially cured polymeric matrix, and then incorporating an effective amount of a photochromic moiety into the surface layer either before or after substantially completely curing the remainder of the polymeric substrate.

### BACKGROUND OF THE INVENTION

The present invention relates to photochromic articles and to a method of making photochromic articles. In one preferred embodiment, the present invention relates to transparent articles and particularly to ophthalmic or planar lenses having a layer which contains a photochromic moiety.

Photochromic molecules and uses for photochromic molecules have been known for many years. For example, lens manufacturers have developed photochromic glass lenses and photochromic plastic lenses which have been commercially successful. Eyeglasses having photochromic lenses have been popular for many years and are both aesthetically pleasing and functional. Photochromic lenses protect eyes because they have the ability to adjust the density of their tint. They are quite transparent and can be worn during low light conditions but they darken when exposed to sunlight or UV light. It is, of course, the photochromic material which has been added to, or coated onto, the lens which changes state under different light conditions to give the lens its photochromic nature.

Although glass lenses with photochromic characteristics are advantageous, plastic lenses with photochromic characteristics are even more advantageous. Plastic lenses are relatively lighter in weight and can be thinner and more resistant to shattering than glass lenses. Although high quality plastic lenses fashioned from so called optical quality resins, are not as hard as glass, the lenses can be coated with a scratch resistant coating and are then both optically clear and scratch resistant. There remains a need, however, for improvements in incorporating photochromic molecules into plastic lenses. The photochromic molecules used in plastic lenses are relatively large in size and are difficult to incorporate into a polymerized plastic polymeric matrix. Difficulties also arise if the polymeric matrix interferes with the changing of states of the photochromic molecule.

Several different techniques are known for adding photochromic material to plastic lenses. In the “casting” technique, the photochromic material is added to a polymerizable optical quality monomer before polymerization and then the mixture is cast in a mold wherein the monomer is polymerized to provide a full body photochromic lens which is a homogeneous mixture of polymer and photochromic material throughout the lens. However, this technique encounters difficulties with regard to providing a lens having even tint or shading from the center of the lens to its edge. If the lens is an ophthalmic lens having a relatively thin optical center area and a relatively thick edge area, the thin center of the lens will have less photochromic additive and will tend to be lighter than the thicker edge.

One variation of casting technique is taught in U.S. Pat. No. 5,882,556 which issued on Mar. 16, 1999 to Perrott et al. for “Method of Preparing Photochromic Article.” In the Perrott et al. method, a cross-linkable polymeric casting composition is subjected to a partial cure, such that the polymer reaches or exceeds its point of gelation, then the partially cured polymer is contacted with a photochromic composition, and the gelled polymer is finish cured. This method has shortcomings, for example, with respect to cracking of finished lenses, which the present invention overcomes.

Another known technique for adding photochromic material to a plastic lens is the “imbibing” technique in which a photochromic material is added to a plastic lens by first polymerizing an optical quality monomer in a mold until polymerization is substantially complete, and then permeating the lens or lens surface with a photochromic material by imbibition, sublimation or other method. This technique provides a layer of photochromic material of consistent depth and thus avoids the problem associated with a lens having a variation in thickness and has become the most prevalent technique in use today. The imbibing technique is, however, relatively complex and expensive. It also tends to be a slow process which is capital intensive and not suitable to be economically carried out in the optical wholesale laboratories which presently surface and edge lenses for most wearers of ophthalmic glasses.

Another technique for rendering an eyeglass lens to be photochromic is a “coating” technique. For example, one coating method involves depositing photochromic molecules onto a lens from a bipolar mixture of solvent and photochromic molecules and then heating the resultant lens and coating to the melting point of the molecules. A hard coating is then applied over the coating of photochromic molecules to protect the molecules and provide scratch resistance. This technique, however, has met with only limited success.

There remains a need for further improvements in techniques or methods for imparting a photochromic feature to articles such as lenses. There is a need for a process that provides large enough spaces within the lens surface layer to accept the relatively large photochromic molecules and which allows the molecules to freely change state to thereby exhibit the full range of their photochromic performance. Furthermore, there remains a need for lower cost methods which are suitable for use in planar lenses and inexpensive reading lenses as well as in relatively expensive ophthalmic lenses. There remains a need for further improvements in the longevity of the photochromic characteristic of the lenses. Presently known plastic photochromic lenses have a limited useful life. Thus, it would be desirable to have a process which providing a photochromic feature which was useful for a longer time. It also would be desirable to have a process which provided a plastic photochromic lens which improved resistance to damage to its photochromic nature due to repeated or long exposure to heat or light. It also would be desirable to have a lens or other article with increased speed in changing from the activated to the non-activated state.

The present invention provides an improved method for imparting photochromic qualities to plastic articles and provides an improved photochromic plastic article. The present invention is useful to make all sorts of photochromic articles or products, and such articles and products are within the broad scope of the invention disclosed herein. However, the present invention is particularly well suited for use in making lenses for eyeglasses. The method of this invention can be economically carried out in a small optical laboratory without use of complex or expensive equipment or process steps to provide a photochromic lens that rapidly changes state, is resistant to damage due to heat or light, and has a long life expectancy. Further understanding of this invention will be had from the following disclosure taken in conjunction with the claims and drawing.

In accordance with the present invention, an article has a substrate comprised of a cross-linked organic polymer matrix. The substrate has a surface with an associated surface layer. The polymer in the surface layer is more porous because it has less cross-linking than the polymer in the remainder of the substrate. The surface layer contains a photochromic moiety. In a preferred embodiment, the article is transparent or semitransparent. In another preferred embodiment the article is an optical lens.

In accordance with the method of the present invention, an article is made by the steps of:
Curing a cross-linkable pre-polymer to at least a gel state to form a substrate of a partially cured polymeric matrix;
inhibiting further curing of said prepolymer in said surface layer, thereby providing a substrate with an inhibited surface layer and an uninhibited partially cured remainder; and
Infusing an effective amount of a photochromic moiety into said surface layer.

The uninhibited partially cured remainder of the substrate is preferably fully cured before the photochromic moiety is infused into the surface layer. However, the uninhibited partially cured remainder can alternatively be cured before the photochromic moiety is infused into the surface layer. The resulting substrate has a porous, partially cured polymeric surface layer containing a photochromic moiety and has a polymeric remainder which is substantially more cross-linked. In one preferred embodiment of the present invention, the method is used to make a transparent article. In another preferred embodiment of the present invention the method is used to make a lens.

### BRIEF DESCRIPTION OF THE DRAWINGS

FIG. 1 is a perspective view of a lens made in accordance with a preferred embodiment of the present invention;

FIG. 2 is a sectional view taken along line 2-2 in FIG. 1;

FIG. 3 is a somewhat schematic view showing the cross-linking of the polymeric matrix in one embodiment of the present invention; and

FIG. 4 is a block diagram showing the method steps of a preferred embodiment of the present invention.

### DETAILED DESCRIPTION OF THE INVENTION

The present invention is a substrate comprised of a cross-linked organic polymer. The substrate has a surface with an associated surface layer and a remaining portion. The surface layer has a matrix of a porous cross-link impaired polymer within which matrix is a photochromic moiety. Some of the cross-linking sites of the polymer in the surface layer are impaired so that the cross-linking in this layer is less than that of the polymer in the remainder of the substrate. Thus, the remaining portion of the substrate is comprised of cross-linked polymer which has substantially more cross-linking than the polymer of the surface layer.

It will be appreciated by those skilled in the art that the present invention is broadly applicable to make substrates which may be used in conjunction with many different photochromic products or articles of manufacture. Examples of products which can comprise or include substrates of this invention include but are not limited to window panes, such as window panes in homes or other energy efficient buildings or solar structures, sun roofs, windshields or lights for automobiles, signs, compact discs, digital audio discs, and plastic optical articles generally. While it is contemplated that most advantage will be taken from use of this invention in transparent or semi-transparent products, this invention can be used to make products that are not transparent, where, for example it may be desired to reduce reflection, or to darken or change the color or appearance of the product. Many different products or articles may be produced with a desirable photochromic effect. All of these products are considered to be within the broad scope of the present invention.

A preferred embodiment of this invention is a photochromic plastic optical lens. Another preferred embodiment is a photochromic eyeglass frame. A further preferred embodiment is a photochromic eyeglass frame with photochromic lenses. Where the embodiment is a lens, the lens may be an ophthalmic lens or a planar lens. Planar lenses are generally of consistent thickness. Ophthalmic lenses may be spherical or aspheric, monofocal, bifocal, trifocal, multifocal, invisible multi-focal or progressive, semi-finished or finished plano blank for sunglasses and do not have a consistent thickness from center to edge. Ophthalmic lenses are relatively difficult to coat or infuse with a photochromic moiety to obtain a consistent photochromic effect. In accordance with the present invention, however, a consistent photochromic layer of consistent thickness can be provided in an ophthalmic lens. Of course, it should be noted that in some cases it may be desirable to have a gradient effect in a lens, i.e., greater darkening in a top of the lens than the bottom of the lens. This effect can also be achieved within the scope of this invention.

The products of the present invention can be made by the method of the present invention which comprises the steps of:
Curing a crosslink-able pre-polymer to at least a gel state to Form a substrate of a partially cured polymeric matrix, the substrate having a surface and an associated surface layer;
inhibiting further curing of said prepolymer in the surface layer, thereby providing a substrate with an inhibited surface layer and an uninhibited partially cured remainder; and
Infusing an effective amount of a photochromic moiety into said surface layer.

The uninhibited partially cured remainder of the substrate is preferably fully cured before the photochromic moiety is infused into the surface layer. However, the uninhibited partially cured remainder can alternatively be cured before the photochromic moiety is infused into the surface layer. The resulting substrate has a porous, partially cured polymeric surface layer containing a photochromic moiety and has a polymeric remainder which is substantially more cured.

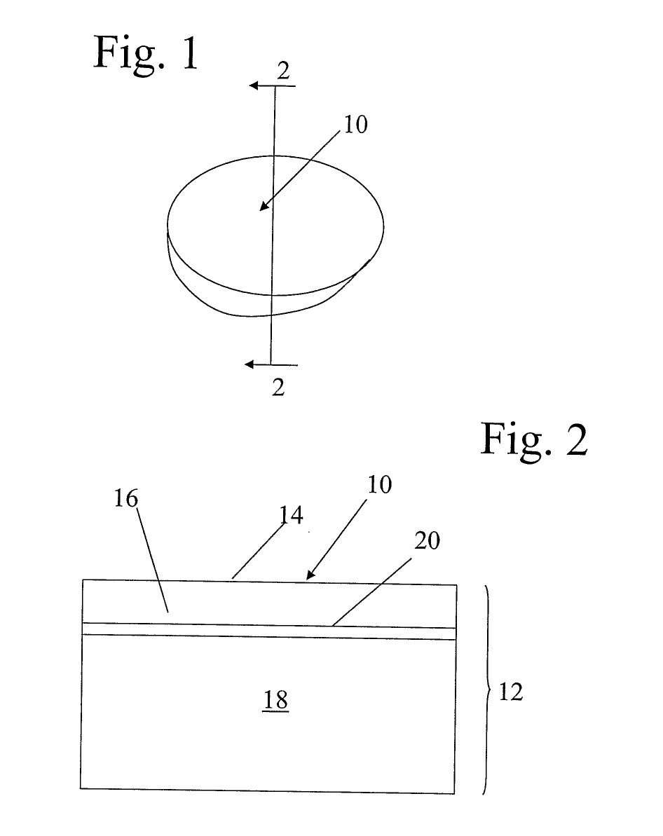

Now referring to the Figures, FIG. 1 shows a preferred embodiment of the present invention, a lens which is indicated generally by the numeral 10. As shown in FIG. 2, lens 10 is a substrate 12 with a surface 14 and an associated surface layer 16. Surface layer 16 transitions to remainder 18 of substrate 12 at zone 20.

Substrate 12 is an organic polymeric matrix made from a polymerizable pre-polymer that has been polymerized and cross-linked. As used herein, the term prepolymer includes monomeric moieties as well as oligomers, dimmers, etc. The prepolymer is polymerized and cross-linked during curing to form a thermoset plastic material. Suitable pre-polymers are well known and may be ultraviolate cross-linkable pre-polymers, radiation cross-linkable pre-polymers or thermally cross-linkable pre-polymers. Initiation of polymerization and/or cross-linking may be by ultraviolet or electron beam radiation or heat or a combination thereof.

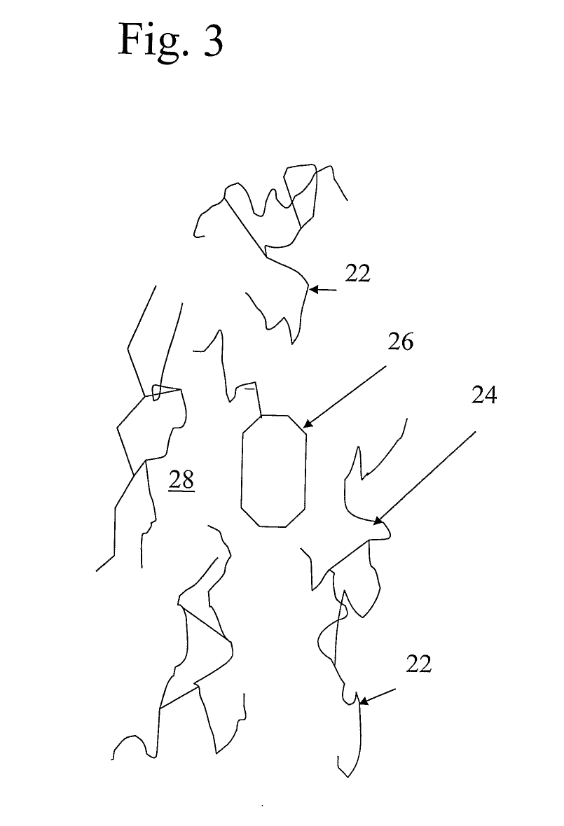

As shown somewhat schematically in FIG. 3, substrate 12 comprises a multiplicity of polymer chains 22 with crosslinks 24. The polymeric matrix of remainder 18 differs from the polymeric matrix of surface layer 16 in that the polymer of remainder 18 is substantially fully cured or crosslinked while the polymer of surface layer 16 is less cross-linked because some of the crosslinking sites of the polymer have been impaired or inhibited to prevent them from cross-linking. Because surface layer 16 is not substantially completely cross-linked, the polymeric matrix of surface layer 16 is relatively porous and is more porous than is the polymeric matrix of remainder 18. Surface layer 16 thus is well adapted to be readily permeated or infused with photochromic molecules 26. Furthermore, because of its relatively low degree of cross-linking, the polymeric matrix of surface layer 16 enables the surface layer 16 to be more expansive and of a more flexible nature to so that photochromic molecules 26 can readily change state.

For an optical quality lens, the present method requires an optical quality polymerizable pre-polymer having an index of refraction between 1.45 and 1.90. Suitable pre-polymers for use in making lenses are liquid and must be placed in a desired lens mold before initiation of polymerization. Examples of suitable pre-polymers include monomers, homopolymers and copolymers of polyol(allyl carbonate) monomers, homopolymers and copolymers of polyfunctional acrylate monomers, polyacrylates, poly(alkylacrylates) such as poly(methylmethacrylate), cellulose acetate, cellulose triacetate, cellulose acetate propionate, cellulose acetate butyrate, poly(vinyl acetate), poly(vinyl alcohol), poly(vinyl chloride), poly(vinylidene chloride), polyurethanes, polycarbonates, poly(ethylene-terephthalate), polystyrene, copoly(styrene-methylmethacralate), copoly(styrene-acrylonitdrile), poly(vinylbutyral), and homopolymers and copolymers of diallylidene pentaerythritol, such as copolymers with polyol(allyl carbonate) monomers, e.g. diethylene glycol bis(allyl carbonate), and acrylate monomers. Transparent copolymers and blends of the transparent polymers are suitable as matrix materials. Preferred pre-polymers are diethlene glycol Bis (allyl carbonate), (CR-39) monomer. Of course, it is contemplated that the polymerizable pre-polymer will be a composition which may comprise other components as is conventional in the art. For example, a suitable composition may include a polymerization initiator, a cross-linking agent, a UV absorber, or other additives conventionally used in the manufacture of lenses. Suitable pre-polymers, initiators, cross-linking agents, additives and other lens materials for use in the present invention are disclosed in U.S. Pat. No. 5,882,556, Mar. 16, 1999 to Perrott et al. which is specifically incorporated by reference herein.

Suitable photochromic molecules for use herein are well-known in the art and include those selected from the group consisting of anthraquinones, naphtopyrans, phhalocyanines, spiro-oxazines, chromenes, pyrans including spiro-pyrans and fulgides. Suitable photochromic molecules include but are not limited to those disclosed in U.S. Pat. No. 5,882,556 Mar. 16, 1999 to Perrott et al. which is specifically incorporated by reference herein. In addition to photochromic molecules, the photochromic composition may include a non-photochromic dye if it is desired to provide a tint to the lens even when the photochromic molecules are not activated. UV stabilizers and antioxidants may be added to enhance the life of the lens.

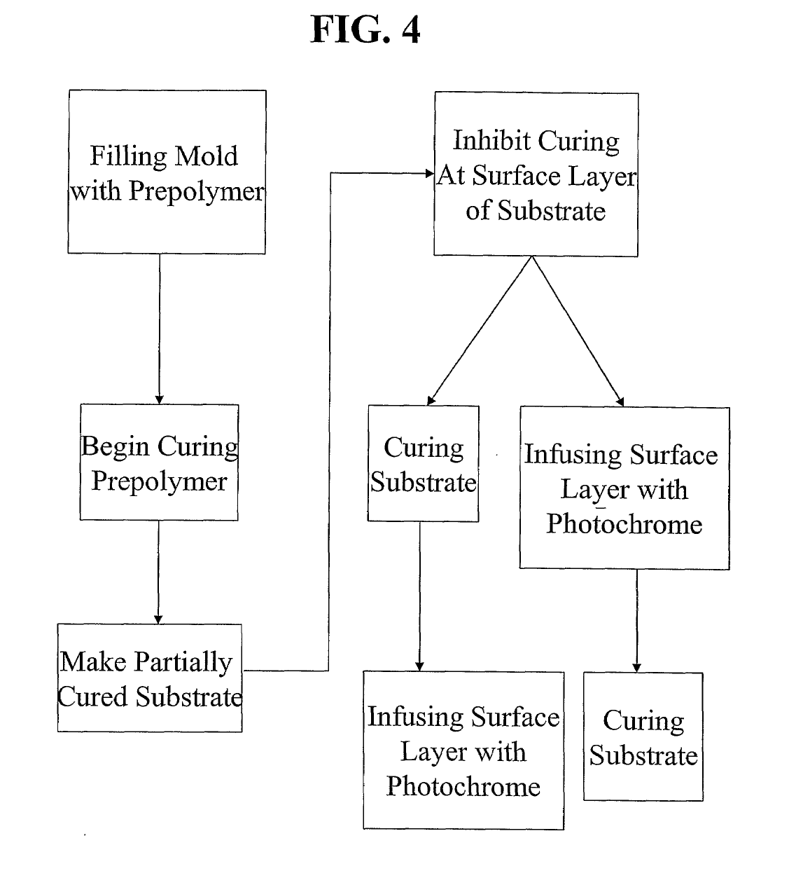

As illustrated in FIG. 4, one embodiment of the present invention is a method for making a photochromic substrate. In accordance with this method, a mold is prepared by filling it with pre-polymer liquid composition. Curing of the prepolymer is begun by heating or otherwise initiating curing as is conventional in the art and disclosed, for example, in the aforementioned U.S. Pat. No. 5,882,556. When the pre-polymer composition has cured to at least its point of gelation, i.e. to a substrate having a gelatinous state, but before the polymer is completely cured, the surface layer of the substrate is contacted with an inhibiting or impairing agent to stop further crosslinking of the polymer in the surface layer. Where the reaction is a free-radical reaction, inhibition can be accomplished by contacting the surface of the substrate with air, diphenylamine (DPA), tert-butyl catechol (TBC), copper chloride, parabenzoquinone, butylated hydroxy toluene (BTH) or any other agent that will inhibit or block the free radical reaction. One alternative way of inhibiting cross-linking in the surface layer is to coat a surface of a lens mold with a free radical inhibitor in powder form before filling the mold with the pre-polymer composition. Yet another way of inhibiting cross-linking is to mix an inhibitor with a carrier such as a mold release agent which is coated on the surface of the lens mold.

Preferably, the polymer in the remainder of the substrate is then cured substantially to completion by further heating or radiation or combination of and then photochromic molecules are infused or permeated into the surface layer by contacting the layer with a solution of photochromic Molecules. Alternatively, the surface layer is infused or permeated with photochromic molecules by contacting the surface with a solution of photochromic molecules and then the polymer in the remainder is cured substantially to completion.

The photochromic moiety can be brought into contact with the surface layer of the substrate to accomplish its permeation therein by various methods including, but not limited to, coating a solution containing the photochromic moiety onto the surface of the substrate, applying a layer of polymeric film having the photochromic moiety dissolved or suspended therein to the surface of the substrate and then heating the film near to but below the melting point of the photochromic moiety for a time sufficient to incorporate the photochromic moiety into the surface layer, or any of the methods for incorporating photochromic compounds into a surface of a host material disclosed in U.S. Pat. No. 5,066,818 Nov. 19, 1991 to Gemert et al. for “Photochromic Naphtopyran Compounds” which patent is specifically incorporated by reference herein.

Further understanding of the present invention will be had from the following examples.

### EXAMPLE 1

Diethylene glycol bis(allyl carbonate) (CR39) monomer from PPG is mixed with an aliphatic peroxy initiator diisoproypyl peroxydicarbonate and injected into a glass mold to produce a 70 mm round by 2 mm thick plano lens blank. The mold is then placed in a curing oven that is cycled to reach a maximum temperature Of 78° C. within 16 hours. During this time the monomer polymerizes to a gelled state. The mold is removed from the curing oven, quenched in ice water and the gelled lenses are removed from the molds and immediately contacted with the atmosphere which acts as a free radical inhibitor.

The lens has a porous surface layer with a less cross-linked structure. The porous surface has many ideal interstitial spaces in the surface layer for photochromic molecules to reside.

The lens is placed back into the curing oven for post curing in the presence of air, which at elevated temperatures is a good inhibitor, for 4 hours to complete the curing of the lens.

The surface of the lens is then contacted with a photochromic solution which imbibes, absorbs or infuses photochromic moieties into the porous surface layer. The photochromic solution is Reversacal Corn yellow from Keystone Aniline Corporation. The resultant lens exhibits superior Photochromic qualities. It is then treated with UV inhibitors and scratch resistant coated to enhance the life of the Photochromic effect and the scratch resistance of the treated lens.

### EXAMPLE 2

The procedure of Example 1 is followed except that the lens is contacted with a solution of 5% DHP in toluene while still in the mold instead of the atmosphere, then the lens is removed from the mold and the procedures of Example 1 are followed. The photochromic solution is Reversacal Berry Red from Keystone Aniline Corporation.

### EXAMPLE 3

The procedure of Example 2 is followed except that after contacting with 5% BHT solution, the lens is cleaned and post cured for 4 hours at 80 C and then tinted with photochromic material. The photochromic material is Reversacal Plum Red from Keystone Aniline Corporation.

### EXAMPLE 4

The procedure of Example 1 is followed except that the lens is contacted with 3% solution of BHT in toluene, cleaned and post cured for 4 hours at 80C. The lens is then tinted with photochromic material. The photochromic material is Reversacal Midnight Gray from Keystone Aniline Corporation.

### EXAMPLE 5

The lens of Example 1 is taken and then placed in a solution of propylene glycol, DE and silicone oil for 20 minutes. Some of the photochromic material was removed from the lens by the solution which thereby reduced the darkening effect of the remaining photochromic material. The removed photochromic material was then recycled to the tinting solution.

### EXAMPLE 6

The method of Example 1 is followed except that after the lens is removed from the mold and the surface layer is inhibited, the surface layer is imbibed with an inert substance, an azo compound. Then after the lens is post cured, the azo compound is leached from the lens using a hot solution of propylene glycol. Then the lens is contacted with a photochromic material which is imbibed into the surface layer of the lens.

What is claimed is:

1. A substrate comprising an organic polymeric matrix, said substrate having a surface with an associated surface layer and a remainder, said surface layer comprising a porous matrix of a polymer with impaired cross-linking and a photochromic moiety, said remainder comprising a polymer which is substantially completely cross-linked.

2. A substrate as in claim 1 wherein said substrate comprises a homogeneous polymeric matrix.

3. A substrate as in claim 1 wherein said substrate is an optical lens.

4. A substrate as in claim 1 wherein said substrate is a planar optical lens.

5. A substrate as in claim 1 wherein said surface layer includes a dye.

6. A substrate as in claim 1 wherein said surface layer comprises an amount of photochromic moiety sufficient to be opaque when activated.

7. A substrate as in claim 1 wherein said substrate is in operative association with an automotive vehicle.

8. A substrate as in claim 1 wherein said substrate is associated with an architectural structure.

9. A transparent optical lens having a first homogeneous layer of a substantially cured organic polymer and a second homogeneous layer of a partially cured organic polymer, said second layer comprising an effective amount of a photochromic moiety.

10. An article as in claim 1 wherein said article is a lens.

11. A method of making a transparent article comprising the steps of:
polymerizing a cross-link able pre-polymer to form a partially cured substrate, said substrate having a surface and an associated surface layer;
inhibiting further polymerization of said prepolymer in said surface layer of said substrate, thereby providing an inhibited surface layer and an uninhibited partially cured substrate portion; and
contacting said surface layer of inhibited partially cured substrate with an effective amount of a photochromic moiety.

12. The method of claim 11 including the step of substantially curing said uninhibited partially cured substrate portion before contacting said surface layer with said photochromic moiety.

13. The method of claim 11 including the step of substantially curing said uninhibited partially cured substrate portion after contacting said surface layer with said photchromic moiety.

14. The method of claim 11 wherein said substrate comprises a homogeneous polymeric matrix.

15. The method of claim 14 wherein said method is followed by the step of mounting said substrate as a lens in an eyeglass frame.

16. The method of claim 14 wherein said substrate is a planar optical lens.

17. The method of claim 11 wherein said prepolymer is a multifunctional polycarbonate prepolymer.

18. The method of claim 17 including contacting said surface layer with a dye which is not photochromic.

19. The method of claim 11 wherein said surface layer comprises an amount of photochromic moiety effective to make said substrate opaque when activated.

20. The method of claim 11 including an additional steps of laminating said substrate onto an article of manufacture and attaching said substrate to an automotive vehicle.
